(19) United States
(12) Patent Application Publication
(10) Pub. No.: US 2016/0069706 A1
(43) Pub. Date: Mar. 10, 2016

(54) METHOD FOR PROVIDING DIRECTIONS IN A MAPPING APPLICATION UTILIZING LANDMARKS ASSOCIATED WITH BRAND ADVERTISING

(71) Applicants: Bruce W. Murphy, Pyrmont (AU); Arnold Binas, Kirribilli (AU)

(72) Inventors: Bruce W. Murphy, Pyrmont (AU); Arnold Binas, Kirribilli (AU)

(73) Assignee: GOOGLE INC., Mountain View, CA (US)

(21) Appl. No.: 13/594,709

(22) Filed: Aug. 24, 2012

(51) Int. Cl. G01C 21/36; G01S 19/42; G01C 21/34

(52) U.S. Cl. CPC G01C 21/3682; G01C 21/3673; G01C 21/3415; G01C 21/343; G01S 19/42

(57) ABSTRACT

A system and machine-implemented method for supplementing navigation routes with landmarks is provided. A navigation route between an origination point and a destination point is received, where the navigation route includes one or more points of divergence. Landmarks located at the one or more points of divergence are identified. One of the identified landmarks located at one of the points of divergence is selected and incorporated into the navigation route at one of the points of divergence. The navigation route with the incorporated landmark is provided for display.

### BACKGROUND

The present disclosure generally relates to providing directions in a mapping application, and, in particular, to providing directions by utilizing landmarks associated with brand advertising in a mapping application.

Mapping applications traditionally provide navigation information based on street names and distance of travel. For example, a mapping application may indicate to a user that the user needs to turn left onto Main Street in 0.5 miles. This type of navigation information, while technically accurate, may be ineffective in areas with a dense amount of streets and areas with streets that lack signs. Thus, it may be desirable to implement a mapping application that provides navigation information reinforced with information including landmarks along a proposed route.

### SUMMARY

The disclosed subject matter relates to a machine-implemented method for supplementing navigation routes with landmarks. A navigation route between an origination point and a destination point is received, where the navigation route includes one or more points of divergence. Landmarks located at the one or more points of divergence are identified. One of the identified landmarks located at one of the points of divergence is selected and incorporated into the navigation route at the one of the points of divergence. The navigation route with the incorporated landmark is provided for display.

The disclosed subject matter also relates to a machine-readable medium comprising instructions stored therein, which when executed by a system, cause the system to perform operations including receiving navigation routes between an origination point and a destination point from a mapping application. Each of the received navigation routes comprises an associated preference score. Landmarks along the navigation routes, each of which includes a prominence score, are identified. The navigation routes are then ranked based on combinations of a preference score associated with each navigation route and a cumulative prominence score of landmarks along the navigation route. A navigation route with the highest rank is provided to the mapping application for display. The navigation route incorporates information on the landmarks along the route with the highest rank.

According to various aspects of the subject technology, a system comprising one or more processors and a machine-readable medium comprising instructions stored therein, which when executed by the processors, cause the processors to supplement navigation routes with landmarks, is provided. A navigation route between an origination point and a destination point is received, where the navigation route includes one or more points of divergence. Landmarks located at the one or more points of divergence are identified. The landmarks include business establishments having an associated advertisement revenue. An identified landmark located at one of the points of divergence is selected based on the associated advertisement revenue, and incorporated into the navigation route at one of the points of divergence. The navigation route with the incorporated landmark is provided for display.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment which provides for supplementing navigation routes with landmarks.

FIG. 2 illustrates an example of a server system for supplementing navigation routes with landmarks.

FIG. 3 illustrates an example method for supplementing navigation routes with landmarks.

FIG. 4 provides a graphical representation of an example navigation route where multiple landmarks are incorporated.

FIG. 5 illustrates an example method for determining navigation routes based on landmarks.

FIG. 6 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The disclosed subject matter relates to a machine-implemented method for supplementing navigation routes with landmarks. A navigation route between an origination point and a destination point is received, where the navigation route includes one or more points of divergence. Landmarks located at the one or more points of divergence are identified. One of the identified landmarks located at one of the points of divergence is selected and incorporated into the navigation route at one of the points of divergence. The navigation route with the incorporated landmark is provided for display.

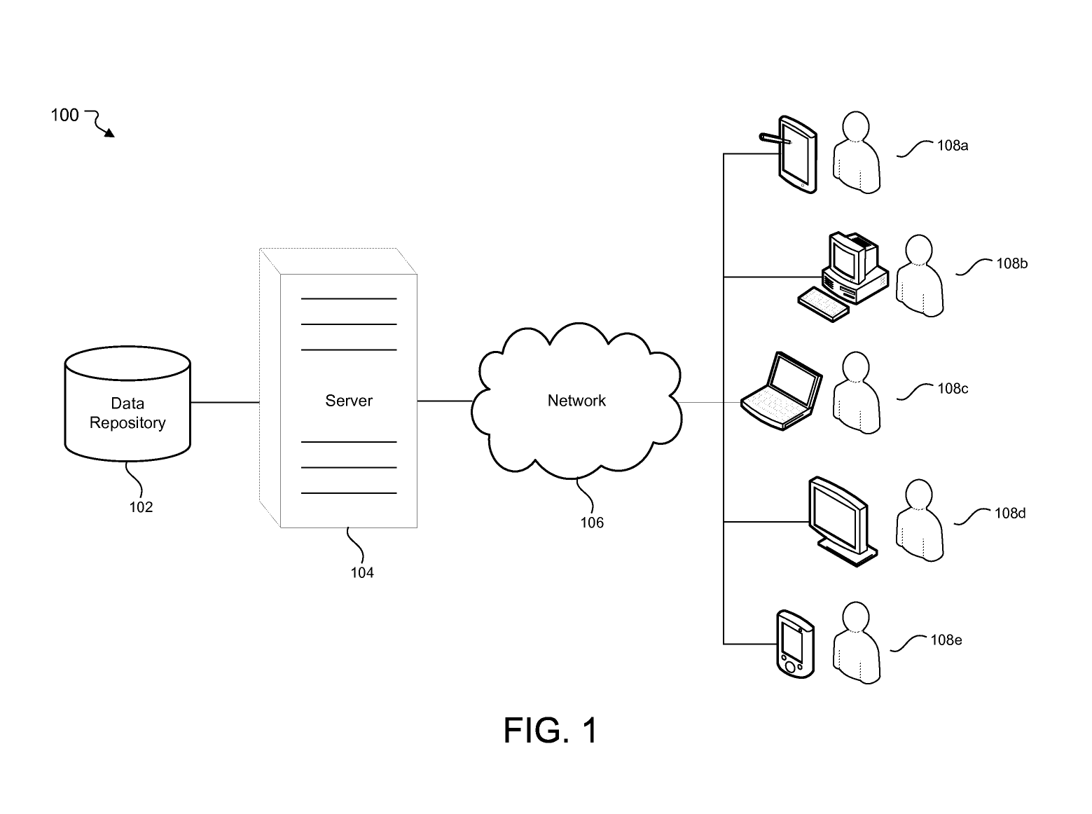

FIG. 1 illustrates an example network environment which provides for supplementing navigation routes with landmarks. Network environment 100 includes a data repository 102 (e.g., computer-readable storage media) for storing a variety of data accessed by web-based applications. While the network environment 100 includes a single data repository 102 in FIG. 1, the network environment may include additional data repository in some implementations. Data repository 102 may store maps and images associated with geographic locales.

The network environment 100 further includes server 104. While the network environment 100 includes a single server in FIG. 1, the network environment may include several interconnected servers in some implementations. Server 104 may receive requests from user-operated client devices 108a-108e. Server 104 and client devices 108a-108e may be communicatively coupled through a network 106. In some implementations, client devices 108a-108e may request data from server 104. Upon receiving the request, server 104 may retrieve a set of data from data repository 102 and serve the set of information to client devices 108a-108e.

Each of client devices 108a-108e can represent various forms of processing devices. Example processing devices can include a desktop computer, a laptop computer, a handheld computer, a television with one or more processors embedded or coupled thereto, a personal digital assistant (PDA), a network appliance, a camera, a smart phone, a media player, a navigation device, an email device, a game console, or a combination of any these data processing devices or other data processing devices. Each of client devices 108a-108e may be any machine configured to generate and transmit a signal that includes location information (e.g., GPS coordinates) to server 104. In some aspects, client devices 108a-108e may include one or more client applications (e.g., mapping applications, GPS applications, or other processes) configured to generate and transmit GPS signals to a server. The GPS signals may include GPS coordinates (e.g., longitude and latitude coordinates) and, in some cases, a time stamp indicating when the GPS signal was generated.

In some aspects, client devices 108a-108e may communicate wirelessly through a communication interface (not shown), which may include digital signal processing circuitry where necessary. The communication interface may provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, such as using a Bluetooth, WiFi, or other such transceiver.

In some aspects, network environment 100 can be a distributed client/server system that spans one or more networks such as network 106. Network 106 can be a large computer network, such as a local area network (LAN), wide area network (WAN), the Internet, a cellular network, or a combination thereof connecting any number of mobile clients, fixed clients, and servers. In some aspects, each client (e.g., client devices 108a-108e) can communicate with servers 104 via a virtual private network (VPN), Secure Shell (SSH) tunnel, or other secure network connection. In some aspects, network 106 may further include a corporate network (e.g., intranet) and one or more wireless access points.

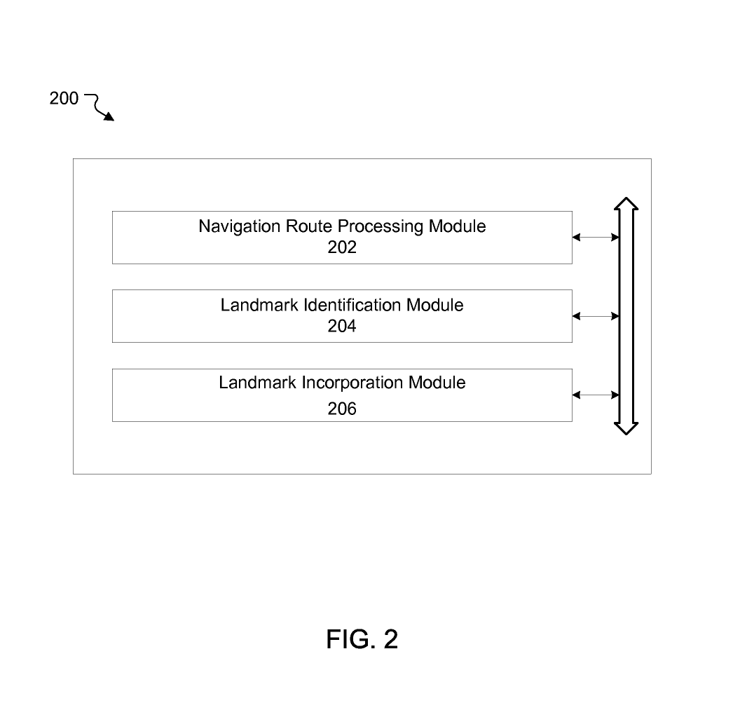

FIG. 2 illustrates an example of a system for supplementing navigation routes with landmarks. System 200 includes navigation route processing module 202, landmark identification module 204, and landmark incorporation module 206. These modules, which are in communication with one another, process information retrieved from data repository 102 in order to supplement navigation routes with landmarks. For example, a navigation route may be received by navigation route processing module 202. Navigation route processing module 202 may further process the navigation route to identify points of divergence. Landmarks located at the points of divergence are identified and selected by landmark identification module 204. The selected landmarks are then incorporated into the navigation route at the points of divergence by landmark incorporation module 206. The navigation route is provided for display with the incorporated landmark.

In some aspects, the modules may be implemented in software (e.g., subroutines and code). The software implementation of the modules may operate on web browsers running on client devices 108a-108e. In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

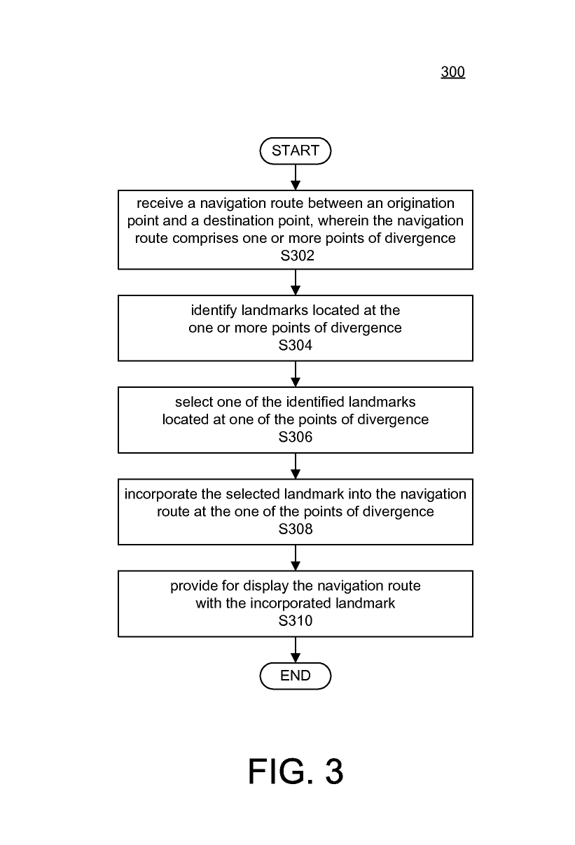

FIG. 3 illustrates an example method for supplementing navigation routes with landmarks. A navigation route between an origination point and a destination point is received in S302. For example, origination and destination points may be submitted in a request for a navigation route. In response to the submission, a navigation route including one or more thoroughfares (e.g., highways, roads, alleyways, trails, etc.) that cumulatively provides a route from the origination point to the destination point is provided. The navigation route may be provided from a data repository that stores a variety of navigation routes corresponding to a variety of different locations. The navigation route provided may include one or more points of divergence, where each point of divergence corresponds to a transition (e.g., left turns, right turns, etc.) from one thoroughfare into another.

In some aspects, the origination and destination locations may be indicated by a user as addresses that include a combination of information such as street number, street, city, and state/province, zip code, and country. Alternatively, the origination and destination locations may be indicated as GPS coordinates (e.g., longitude and latitude coordinates). In some implementations, the user may enter both the origination and destination locations; however, the origination location may also be derived from a client device configured to generate and transmit GPS signals to a server.

In S304, landmarks located at the one or more points of divergence are identified. In some aspects, the landmarks are stored in a data repository, where each landmark includes information such as a location (e.g., GPS coordinates and/or address), dimensions (e.g., height, length, width, depth), a description (e.g., color, text appearing on the landmark, name of a business to which the landmark corresponds), etc. The landmarks are identified as being at the one or more points of divergence by matching the location information of the landmark with the locations of points of divergence stored in the data repository.

The stored landmarks may correspond to geographic feature such as monuments, buildings (e.g., storefronts, restaurants, offices, etc.), or other structures (e.g., naturally occurring and man made structures). In some implementations, the landmarks may correspond to businesses listings, which are also stored in the data repository. The visibility and prominence of a particular landmark may be determined based on the information stored in the data repository. Thus, each landmark may have a rating that corresponds to visibility and prominence. For example, a large billboard on the side of an open road and within plain sight of drivers and pedestrians may be determined to be highly visible, as opposed to a coffee shop with a small storefront and no visible signage.

Once the landmarks have been identified, one of the identified landmarks located at one of the points of divergence is selected in 5306. Points of divergence may include locations along the navigation route where the client device is prompted to instruct the user to change a direction of travel. For example, when a point of divergence corresponding to a turn in the navigation route is approached by the client device, an audible signal (e.g., turn right in 500 feet onto Main Street) and/or visual signal (e.g., an arrow on the display screen indicating a right turn in 500 feet onto Main Street) may be provided by the client device.

The selected landmark may be incorporated into the navigation route at one of the points of divergence in S308. The navigation route with the incorporated landmark is then provided for display in S310. Incorporating the selected landmark into the navigation route may include modifying the audio and visual signals provided by the client device. The audible signal provided by the client device may include a description of a landmark at the point of divergence in addition to or in replacement of audible signals that simply provide distances and street names (e.g., turn right in 500 feet onto Main Street). For example, when the point of divergence corresponding to a turn in the navigation route within the vicinity of the landmark is approached by the client device, an audible signal that includes a description of the landmark may be provided (e.g., turn right at the first street after Restaurant XYZ).

In some implementations, only landmarks determined to be visible are incorporated into the navigation route. The visibility of a landmark may be determined based on a variety of factors. One such factor is the time of day. By identifying a time of day, a determination of the amount of daylight available for viewing a landmark such as a storefront may be made. The storefront may be visible during the day when an adequate amount of daylight is available, and at night when the corresponding store is open for business. The visibility of the storefront, however, may be compromised during low light conditions that exist between dusk of one day and dawn of the next day, and particularly when the store is closed for business. Weather is an additional condition that may contribute to determining visibility. Weather events such as rain, snow, or fog may diminish visibility, regardless of the time of day or the amount of daylight typically available for that time of the day. The location of the client device in reference to the landmark may be an additional contributing factor in determining visibility. If a landmark is determined to be obstructed by another structure at the location of the user device, the landmark may not be visible from the location of the client device. Accordingly, when a landmark is determined to not be visible, the landmark is not incorporated into the navigation route, and a default navigation route (e.g., one that provides distances and street names) is used.

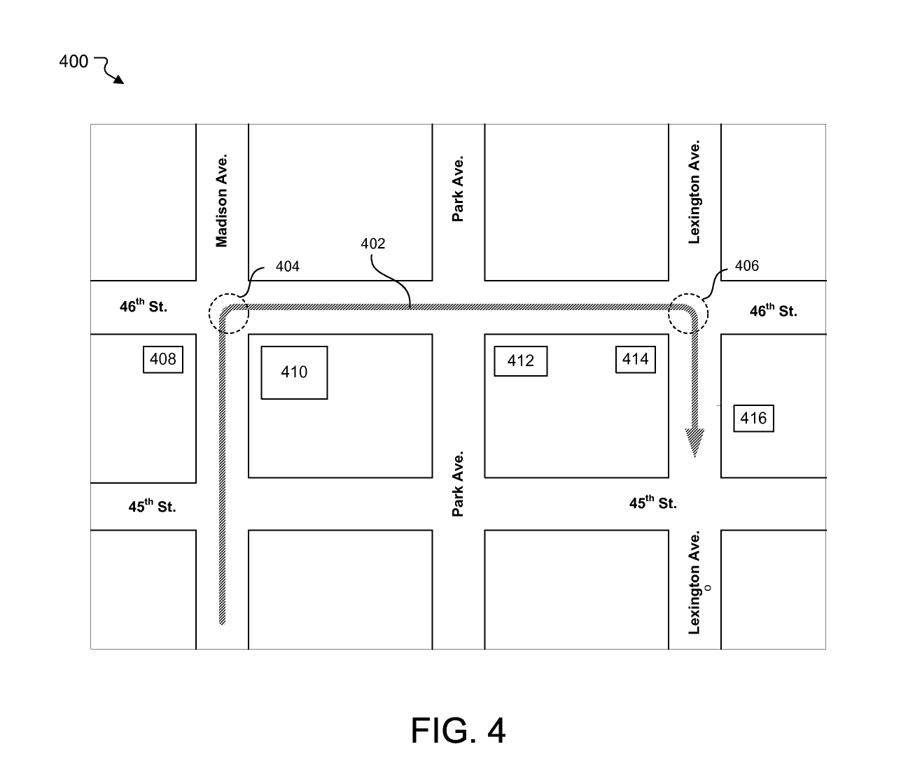

While the above example describes the incorporation of one landmark into the navigation route, multiple landmarks may be selected and incorporated at the different points of divergence. That is, if a navigation route has multiple points of divergence, a different landmark may be selected and incorporated for each of the multiple points of divergence. FIG. 4 provides a graphical representation of an example navigation route where multiple landmarks are incorporated. Navigation route 402 on map 400 includes a first point of divergence 404 and a second point of divergence 406. In some implementations, multiple landmarks may be associated with a same point of divergence. In this example, landmarks 408 and 410 are associated with the first point of divergence 404 and landmark 414 is associated with the second point of divergence 406. Additionally, landmark 416 is associated with the destination of the navigation route. When multiple landmarks are associated with the same point of divergence, a determination may be made as to which landmark is to be incorporated into the navigation route.

In some aspects, the determination may be made based on a prominence score associated with the landmarks. The prominence score of a landmark may be based on factors such as the visibility of the landmark. The visibility of a landmark may be determined from the position and size of the landmark. The position of the landmark may provide an indication of whether the landmark is visible, and more particularly, whether the landmark is visible from a direction of travel. For example, a billboard facing traffic on one side of the street may not be visible to traffic on the opposing side of the street, and vice versa. Thus, the prominence score of the same landmark may vary depending on the direction of travel indicated by the navigation route. Furthermore, landmarks that are larger in size and/or located in higher positions may also be assigned higher prominence scores as both characteristics contribute to better visibility of the landmarks.

In some implementations, landmarks associated with easily identifiable brands may be assigned higher prominence scores. For example, landmarks such as popular fast food restaurant chains and coffee shops may have higher prominence scores than landmarks that are not as familiar or easily identifiable. The prominence score of a landmark may further take into consideration the country, culture, or language of origin associated with the client device on which a user submits a request, since certain brands may be more recognizable to users of a particular country, culture, or language. By adjusting the prominence scores to favor the incorporation of certain landmarks over others into the navigation route, the user is provided with directions that are easier to understand and thus easier to navigate.

In some implementations, landmarks may be associated with locations along the route that are not points of divergence. When a navigation route proceeds along a same thoroughfare for an extended distance, a landmark may be incorporated into the audible and visual signals to provide confirmation that the correct route is being followed. For example, if a navigation route provides directions from Madison Avenue to Lexington Avenue along 46th Street in New York City, an audible signal with the incorporated landmark may be provided. Returning to FIG. 4, an audible signal associated with navigation route 402 may prompt a user of the client device to proceed past landmark 412. For example, the audible signal may prompt the user to “Continue on 46th Street past store XYZ on your right and proceed for 0.1 miles to Lexington Avenue.” A corresponding visual signal may be provided (e.g., landmark 412 is shown on the map) on a display that shows the location of the landmark that corresponds to that which was provided in the audible signal.

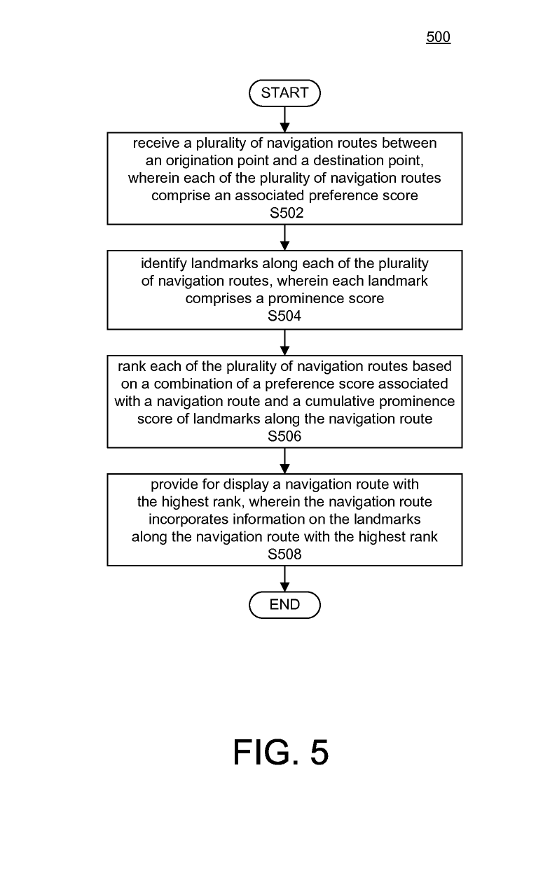

In some implementations, multiple navigation routes may exist between an origination point and a destination point. In these circumstances, a navigation route may be determined based on landmarks between an origination point and a destination point. FIG. 5 illustrates an example method for determining navigation routes based on landmarks. Several navigation routes between an origination point and a destination point are received in S502, where each of the navigation routes includes an associated preference score. While each navigation route shares the same origination and destination points, each navigation route includes a unique set of points of divergence. The preference score of a navigation route may be based on ease of travel associated with the navigation route. Factors that may contribute to the ease of travel may include distance of route, sizes of thoroughfares, number of turns, and number of traffic signals. For example, a shorter route will have a higher preference score than a longer route since less time is required to cover a shorter distance of travel if a same rate of travel is applied.

The sizes of thoroughfares may further contribute to the preference score. When traveling by vehicle, larger thoroughfares (e.g., highways, freeways, etc.) in general will have a faster flow of traffic and higher speed limits than smaller thoroughfares (e.g., alleyways, streets, etc.). However, the sizes of thoroughfares may have less of an impact on preference score if a determination is made that travel is being done by foot. Additionally, the number of turns and number of traffic signals may be taken into consideration for determining the preference score. The preference score may decrease as the number of turns and traffic signals increases, as an increase in the number of turns may reduce the ease of travel, and an increase in the number of traffic signals may increase the amount of time required to navigate the route. Other factors such as traffic (real-time and or historical pattern for time of day and day of week) may also contribute to the determination of a preference score.

In S504, landmarks along each of the navigation routes are identified. As described above by reference to FIG. 3, the landmarks are stored in a data repository, where each landmark includes information such as a location, dimensions, a description, etc. The landmarks are identified as being at the one or more points of divergence by matching the location information of the landmark with the locations of points of divergence stored in the data repository. The landmarks may correspond to geographic features such as monuments, buildings (e.g., storefronts, restaurants, offices, etc.), or other structures (e.g., naturally occurring and man made structures). Each landmark also may include a prominence score.

The prominence score of a landmark may be based on such factors such as the position and size of the landmark. For example, a larger more visible landmark will have a higher prominence score, while a smaller less visible landmark will have a lower prominence score. The visibility of a landmark and thus the prominence score of the landmark may change depending on different lighting conditions. During daylight hours, a landmark's prominence score may be higher as the visibility is higher. Similarly, prominence scores may be higher on clear days as opposed to inclement days.

The navigation routes are ranked based on a combination of a preference score associated with the particular navigation route and a cumulative prominence score of landmarks along the particular navigation route in S506. Navigation routes with higher preference scores and landmarks associated with the navigation route with higher prominence scores will result in a higher ranking of the navigation route. In other words, navigation routes that include factors that contribute to higher preference scores (e.g., distance, thoroughfares traveled, number of turns, number of traffic signals, etc.) and factors that contribute to higher prominence scores of landmarks (e.g., position, size, lighting, weather, etc.) are preferred over navigation routes with a lower combination of scores, since higher ranking navigation routes are associated with routes that are easier to navigate and require shorter durations of travel.

Once the navigation routes are ranked, a navigation route with the highest rank is provided in S508. The navigation route provided includes landmarks that are incorporated into the navigation route. The selected landmark may be incorporated into the navigation route by modifying the audio and visual signals provided by the client device. The audible signal provided by the client device may include a description of a landmark at the point of divergence in addition to or in replacement of audible signals that simply provide distances and street names (e.g., turn right in 500 feet onto Main Street). For example, when the point of divergence corresponding to a turn in the navigation route within the vicinity of the landmark is approached by the client device, an audible signal that includes a description of the landmark may be provided (e.g., turn right at the first street after Restaurant XYZ). Navigation by landmark may be particularly useful in areas that lack adequate street signs. By incorporating landmarks into a navigation route, the user of the client device may be directed by easily identifiable and recognizable structures instead of difficult to read and occasionally non-existent street signs.

In some implementations, identified landmarks may be associated with business establishments such as a restaurant or a retail store. In some aspects, incorporating landmarks associated with business establishments may generate a corresponding advertisement revenue. That is, business establishments may pay a predefined amount to be advertised as a landmark that is incorporated into the navigation route, where the location of the landmark corresponds to the real life location of the business establishment. For example, if Restaurant XYZ is located on the corner of a point of divergence, incorporating Restaurant XYZ into the navigation route (e.g., turn right at the first street after Restaurant XYZ) may generate a revenue under predetermined terms. As discussed above, there may be multiple viable navigation routes between an origination point and a destination point, and each route may have points of divergence where multiple landmarks exist. Accordingly, the selection of a navigation route from the multiple navigation routes and the selection one landmark from several landmarks at a point of divergence may be made based on the additional factor of the amount of revenue generated by each selection. For example, if two landmarks exist for a point of divergence, the landmark that corresponds to a higher advertisement revenue may be selected. Similarly, a navigation route that includes more advertisement based landmarks may be selected over a navigation route with less advertisement based landmarks.

In some implementations, different landmarks may be selected for a navigation route in order to reduce repetitiveness. For example, if Coffee Shop ABC is a chain business establishment and has multiple landmarks along a navigation route, Coffee Shop ABC may be bypassed as a selection for a landmark at a point of divergence in favor of a different landmark that has been identified. Furthermore, a limit may be placed on the percentage and/or total number of advertising landmarks that are incorporated into the navigation route. For example, a limit of 40% may be set as the percentage of total landmarks used in a navigation route. Different percentages and limits may be set in order to maximize brand recognition without diluting the effectiveness of incorporating landmarks into navigation routes.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

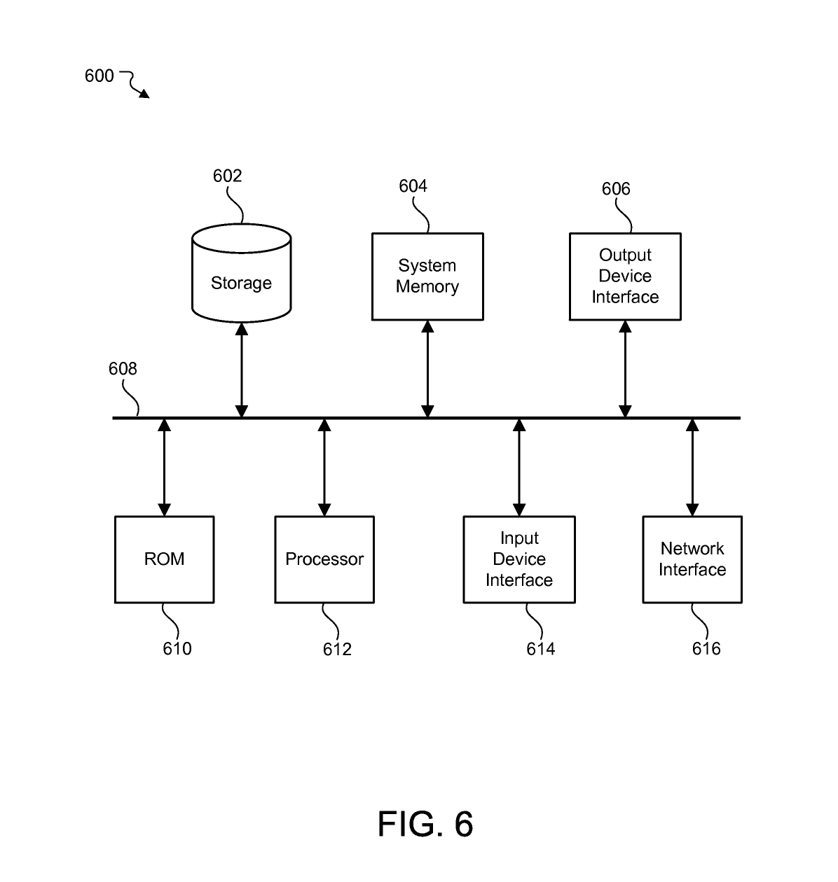

FIG. 6 conceptually illustrates an example electronic system 600 with which some implementations of the subject technology are implemented. Electronic system 600 can be a computer, phone, PDA, or any other sort of electronic device. Such an electronic system includes various types of computer readable media and interfaces for various other types of computer readable media. Electronic system 600 includes a bus 608, processing unit(s) 612, a system memory 604, a read-only memory (ROM) 610, a permanent storage device 602, an input device interface 614, an output device interface 606, and a network interface 616.

Bus 608 collectively represents all system, peripheral, and chipset buses that communicatively connect the numerous internal devices of electronic system 600. For instance, bus 608 communicatively connects processing unit(s) 612 with ROM 610, system memory 604, and permanent storage device 602.

From these various memory units, processing unit(s) 612 retrieves instructions to execute and data to process in order to execute the processes of the subject disclosure. The processing unit(s) can be a single processor or a multi-core processor in different implementations.

ROM 610 stores static data and instructions that are needed by processing unit(s) 612 and other modules of the electronic system. Permanent storage device 602, on the other hand, is a read-and-write memory device. This device is a non-volatile memory unit that stores instructions and data even when electronic system 600 is off. Some implementations of the subject disclosure use a mass-storage device (such as a magnetic or optical disk and its corresponding disk drive) as permanent storage device 602.

Other implementations use a removable storage device (such as a floppy disk, flash drive, and its corresponding disk drive) as permanent storage device 602. Like permanent storage device 602, system memory 604 is a read-and-write memory device. However, unlike storage device 602, system memory 604 is a volatile read-and-write memory, such as random access memory. System memory 604 stores some of the instructions and data that the processor needs at runtime. In some implementations, the processes of the subject disclosure are stored in system memory 604, permanent storage device 602, and/or ROM 610. For example, the various memory units include instructions for supplementing navigation routes with landmarks in accordance with some implementations. From these various memory units, processing unit(s) 612 retrieves instructions to execute and data to process in order to execute the processes of some implementations.

Bus 608 also connects to input and output device interfaces 614 and 606. Input device interface 614 enables the user to communicate information and select commands to the electronic system. Input devices used with input device interface 614 include, for example, alphanumeric keyboards and pointing devices (also called “cursor control devices”). Output device interface 606 enables, for example, the display of images generated by the electronic system 600. Output devices used with output device interface 606 include, for example, printers and display devices, such as cathode ray tubes (CRT) or liquid crystal displays (LCD). Some implementations include devices such as a touchscreen that functions as both input and output devices.

Finally, as shown in FIG. 6, bus 608 also couples electronic system 600 to a network (not shown) through a network interface 616. In this manner, the computer can be a part of a network of computers, such as a local area network, a wide area network, or an Intranet, or a network of networks, such as the Internet. Any or all components of electronic system 600 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network and a wide area network, an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims.

1. A computer-implemented method for supplementing navigation routes with landmarks, the method comprising:
receiving, using one or more computing devices, a navigation route between an origination point and a destination point, wherein the navigation route comprises one or more points of divergence;
identifying, using the one or more computing devices, landmarks located at the one or more points of divergences
determining, using the one or more computing devices, a level of visibility of each landmark on the direction of travel of the route;
assigning, using the one or more computing devices, a prominence score to each of the landmarks, each prominence score being based at least in part on the level of visibility of its associated landmark on the direction of travel of the route;
selecting, using the one or more computing devices, one of the identified landmarks located at one of the points of divergence based at least in part on the prominence scores associated with each of the landmarks;
incorporating, using the one or more computing devices, the selected landmark into the navigation route at the one of the points of divergence; and
providing to a display, using the one or more computing devices, the navigation route with the incorporated landmark.

2. The method of claim 1, wherein the landmarks comprise business establishments.

3. The method of claim 2, wherein providing to a display the navigation route with the incorporated landmark comprises providing to a display a name associated with the business establishment.

4. The method of claim 3, wherein the name associated with the business establishment and provided to a display is utilized for audible signals corresponding to the navigation route.

5. The method of claim 4, wherein the name associated with the business establishment and provided to a display is integrated with turn-by-turn instructions in the audible signals corresponding to the navigation route.

6. The method of claim 1, wherein the selecting one of the identified landmarks located at one of the points of divergence is based on at least one of a position of the landmark and a size of the landmark.

7. The method of claim 1, wherein at least one of the origination point and the destination point is provided by a client device.

8. The method of claim 1, wherein the origination point corresponds to a current location as determined by a global positioning system of a client device, and the navigation route provides directions from the current location to the destination point.

9. A machine-readable medium comprising instructions stored therein, which when executed by a system, cause the system to perform operations comprising:
receiving a plurality of navigation routes between an origination point and a destination point from a mapping application, wherein each of the received plurality of navigation routes comprises an associated preference score;
identifying landmarks along the plurality of navigation routes, each landmark comprising a prominence score;
ranking each of the plurality of navigation routes based on a combination of a preference score associated with a navigation route and a cumulative prominence score of landmarks along the navigation route; and
providing for display on the mapping application, a navigation route with the highest rank, wherein the navigation route incorporates information on the landmarks along the navigation route with the highest rank.

10. The machine-readable medium of claim 9, wherein the preference score associated with a particular one of the plurality of navigation routes is determinable based on an estimated duration of travel of the particular one of the plurality of navigation routes.

11. The machine-readable medium of claim 10, wherein the estimated duration of travel for a route is determinable based on at least one of a distance of the route, sizes of thoroughfares along the route, number of turns in the route, and a number of traffic signals in the route.

12. The machine-readable medium of claim 9, wherein the prominence score of landmarks along the navigation route is determinable based on at least one of a position of the landmark and a size of the landmark.

13. The machine-readable medium of claim 9, wherein the landmarks comprise business establishments.

14. The machine-readable medium of claim 13, wherein the prominence score of a landmark along the navigation route is determinable based on an advertisement revenue associated with a business establishment corresponding to the landmark along the navigation route.

15. The machine-readable medium of claim 14, wherein providing for display on the mapping application the navigation route with the incorporated information on the landmarks comprises providing names associated with business establishments.

16. The machine-readable medium of claim 15, wherein the provided names associated with the business establishments is utilizable for audible signals corresponding to the navigation route.

17. The machine-readable medium of claim 16, wherein the provided name is integratable with turn-by-turn instructions in the audible signals corresponding to the navigation route.

18. A system for supplementing navigation routes with landmarks, the system comprising:
one or more processors; and
a machine-readable medium comprising instructions stored therein, which when executed by the processors, cause the processors to perform operations comprising:
receiving a navigation route between an origination point and a destination point, wherein the navigation route comprises one or more points of divergence;
identifying landmarks located at the one or more points of divergence, wherein the landmarks comprise business establishments having an associated advertisement revenue;
determining a level of visibility of each landmark on the direction of travel of the route;
assigning a prominence score to each of the landmarks, each prominence score being based at least in part on the level of visibility of its associated landmark on the direction of travel of the route;
selecting an identified landmark located at one of the points of divergence based on the associated advertisement revenue and the prominence scores associated with each of the landmarks;
incorporating the selected landmark into the navigation route at one of the points of divergence; and
providing to a display the navigation route with the incorporated landmark.

19. The system of claim 18, wherein providing to a display the navigation route with the incorporated landmark comprises providing to a display a name associated with a business establishment.

20. The system of claim 19, wherein the provided name associated with the business establishment is utilized for audible signals corresponding to the navigation route.
